(19) United States
(12) Patent Application Publication
(10) Pub. No.: US 2012/0061231 A1
(43) Pub. Date: Mar. 15, 2012

(54) GAS SENSOR ELEMENT AND METHOD OF MANUFACTURING THE SAME

(75) Inventors: Kiyomi KOBAYASHI, Kuwana-shi (JP); Zhenzhou Su, Okazaki-shi (JP)

(73) Assignee: DENSO CORPORATION, Kariya-city (JP)

(21) Appl. No.: 13/227,741

(22) Filed: Sep. 8, 2011

(30) Foreign Application Priority Data
Sep. 10, 2010 (JP) 2010-202698
Jun. 30, 2011 (JP) 2011-145453

(51) Int. Cl. G01N 27/407; B05D 3/02; B01J 19/10; B05D 5/12; B82Y 40/00; B82Y 30/00

(52) U.S. Cl. 204/157.42; 204/424; 427/123; 977/780; 977/840

(57) ABSTRACT

A gas sensor element includes a solid electrolyte body having oxygen ion conductivity and electrode layers formed on both surfaces of the solid electrolyte body configuring a pair of electrodes. The gas sensor element detects concentration of a selected component included in a measured gas. In the gas sensor element, closed pores having an average pore diameter of 5 nm or more and 120 nm or less are dispersed in the electrode layers, porosity measured by cross-sectional observation of the electrode layers is 1% or more and 18% or less, and 90% or more of the closed pores is dispersed within metal grains forming the electrode layers.

### CROSS REFERENCE TO RELATED APPLICATION

This application is based upon and claims the benefit of priority from the prior Japanese Patent Application No. 2010-202698, filed Sep. 10, 2010 and the prior Japanese Patent Application No. 2011-145453, filed Jun. 30, 2011, the entire contents of which is incorporated herein by reference.

### BACKGROUND OF THE INVENTION

1. Field of the Invention

The present invention relates to a gas sensor element that measures the concentration of a selected gas component included in a measured gas and is set in an internal combustion engine, an exhaust gas purification apparatus, or the like, and a method of manufacturing the gas sensor element.

2. Description of the Related Art

A gas sensor is provided on an exhaust gas flow path of an internal combustion engine of a vehicle engine or the like. The gas sensor detects the concentration of a selected gas component, such as oxygen, nitrogen oxide (NOₓ), ammonia, or hydrogen, included in exhaust gas as a measured gas. The gas sensor is used in combustion control (air/fuel ratio control) in the internal combustion engine, regeneration control and abnormality detection in the exhaust gas purification apparatus, and the like.

A solid electrolyte sensor element has conventionally been used as a gas sensor element included in the gas sensor.

JP-A-2001-124724 discloses a gas sensor element configured as follows. The gas sensor element includes a solid electrolyte body. The solid electrolyte body is formed into a substantially cylindrical shape with a bottom by using a solid electrolyte material having oxygen ion conductivity such as stabilized zirconia. A pair of electrodes is formed on the inner side and the outer side of the solid electrolyte body. The electrodes are configured by a reference electrode layer and a measuring electrode layer composed of platinum or the like. A porous protective layer for poisoning prevention is further provided on a surface of the measuring electrode layer.

US Patent Publication No. 2002/0011411 A 1 (corresponding with JP-A-2002-48758) discloses a gas sensor element having excellent responsiveness. The gas sensor element is configured by a solid electrolyte body, a reference gas electrode and a target gas electrode formed on the surfaces of the solid electrolyte body. Each electrode is composed of numerous crystal grains. As a result of the grain boundaries of the crystal grains forming each electrode being increased, an area of contact with the gas of each electrode is increased, thereby enhancing responsiveness of the gas sensor element.

The gas sensor element includes therein a heater that generates heat by energization, and is used by heat-activating the solid electrolyte body. The gas sensor element is exposed to high-temperature exhaust gas serving as the measured gas, and is generally used in a high-temperature environment. Therefore, when the gas sensor element is used over an extended period, mass transfer in metal grain surfaces occur as a result of heat in a metal film serving as an electrode layer. The metal film is composed of platinum or the like. As a result, aggregation of metal grains occurs, transmittance of the measured gas in the electrode layer changes, thus leading to risk of deterioration in responsiveness. In particular, in the conventional gas sensor element, bubbles are present in the grain boundaries between metal grains forming the electrode layer. The bubbles present in the grain boundaries have been found to accelerate aggregation of metal grains.

### SUMMARY OF THE INVENTION

The present invention has been achieved in light of the above-described issues. An object of the present invention is to provide a gas sensor element having little change in responsiveness and excellent durability by suppressing aggregation of metal grains over an extended period in an electrode layer formed on a surface of a solid electrolyte body, and a method of manufacturing the gas sensor element.

According to a first aspect of the invention, there is provided a gas sensor element including a solid electrolyte body having oxygen ion conductivity and electrode layers formed on both surfaces of the solid electrolyte body configuring a pair of electrodes. The gas sensor element detects concentration of a selected component included in a measured gas. In the gas sensor element, closed pores having an average pore diameter of 5 nm or more and 120 nm or less are dispersed in the electrode layers, porosity measured by cross-sectional observation of the electrode layers is 1% or more and 18% or less, and 90% or more of the closed pores are dispersed within metal grains forming the electrode layers.

Even when a gas sensor is exposed to a high-temperature exhaust gas environment, stable sensor responsiveness with little durability change is found to have been achieved. The reasons are as follows.

When the gas sensor is exposed to a high-temperature exhaust gas environment, coarsening of the metal grains occur as a result of aggregation of the metal grains forming the electrode layers. In addition, the closed pores increase, and gas diffusivity of the electrode layers increases. As a result, reduction in sensor responsiveness is thought to occur. Here, increase in closed pores refers to increase in either the number of closed pores or the area of closed pores, or both. This phenomenon is thought to occur in accompaniment with mass transfer in the metal grains.

Nano-sized closed pores are present and uniformly dispersed in the electrode layers. Therefore, coarsening of the closed pores does not easily occur because mass transfer within the metal grains is inhibited. Aggregation of the metal grains can also be suppressed.

As a result of the nano-sized closed pores being uniformly dispersed, abnormal enlargement of the closed pores caused by mass transfer occurring in some areas and pores coming into contact with each other can be suppressed. Furthermore, even when aggregation of metal grains occurs, as a result of a so-called pinning effect in which mass transfer is stopped by closed pores present in the vicinity, an effect of suppressing advancement of aggregation of metal grains can be achieved.

The average pore diameter of the closed pores is set to 5 nm or more and 120 nm or less. When the average pore diameter of the closed pores is less than 5 nm, the closed pores do not obstruct mass transfer within the metal grains. Conversely, when the average pore diameter is more than 120 nm, the closed pores function as grain boundaries, and the effect of suppressing mass transfer within the metal grains cannot be achieved. Moreover, it is speculated that mass transfer within the metal grains becomes faster. Therefore, should closed pores having an average pore diameter outside of the range of the present invention be dispersed in the electrode layers, suppressing deterioration in responsiveness is found to be difficult.

It is found to be preferable that a porosity is 1% or more and 18% or less. Here, the porosity refers to a percentage (%) of a total area of the closed pores in relation to a total area of the electrode layers, measured by cross-sectional observation of the electrode layers. The method of determining the porosity will be described hereafter.

The porosity is set to 1% or more and 18% or less. When the porosity is less than 1%, the effect of inhibiting mass transfer by the closed pores cannot be sufficiently achieved. Conversely, when the porosity exceeds 18%, contact between closed pores easily occurs. Because spatial volume is large, mass migration easily occurs, and pore enlargement and aggregation cannot be sufficiently suppressed.

In addition, because bonding force in the grain boundaries between metal grains is weak, mass transfer easily occurs. Pore enlargement and aggregation typically occur with the grain boundaries as the points of origin. Pores present in the grain boundaries tend to move. When numerous closed pores are present in the grain boundaries, a plurality of pores come into contact with each other, thus leading to risk of accelerated pore enlargement and aggregation.

The porosity is required to be 1% or more and 18% or less, as described above. However, even when the porosity is within this range, when the closed pores are present in the grain boundaries, the pores easily move. Therefore, the closed pores are preferably present, not in the grain boundaries, but such that 90% or more are present within the metal grains. As a result, the above-described effects can be achieved.

According to a second aspect of the invention, there is provided a method of manufacturing a gas sensor element by forming at least a metal film configuring an electrode layer on a surface of a solid electrode body having oxygen ion conductivity. The gas sensor element detects concentration of a selected gas component within a measured gas. In the method of manufacturing a gas sensor element, a bubble distribution means is used for dispersing 90% or more of closed pores having an average pore diameter of 5 nm or more and 120 nm or less within metal grains forming the electrode layer by applying fine bubbles on the surface of the solid electrolyte body when forming the metal film by electroless deposition.

It becomes important that the generation of closed pores is suppressed in the grain boundaries. When grain growth progresses excessively, or when bonding between the metal film and its base is weak, relatively large open pores are easily formed in the grain boundaries. 90% of the closed pores are dispersed within the metal grains and furthermore, the closed pores having a desired average diameter are dispersed in the electrode layer. Therefore, fine closed pores are dispersed and formed within the grains of the electrode layer. As a result, the generation of closed pores in the grain boundaries is suppressed, and a sensor element can be manufactured that has little responsiveness durability change over an extended period.

### BRIEF DESCRIPTION OF THE DRAWINGS

The invention will be more particularly described with reference to the accompanying drawings in which:

FIG. 1 is a cross-sectional view of main sections indicating features of an oxygen sensor element according to an embodiment of the present invention;

FIG. 2 is a vertical cross-sectional view of an overall configuration of an oxygen sensor to which the oxygen sensor element according to the embodiment of the present invention is assembled;

FIG. 3A is a cross-sectional view of main sections showing an overview of an oxygen sensor element serving as a comparative example;

FIG. 3B is a cross-sectional view of main sections showing an overview of an oxygen sensor element serving as a comparative example;

FIG. 3C is a cross-sectional view of main sections showing an overview of an oxygen sensor element serving as a comparative example;

FIG. 4A is a characteristics diagram showing responsiveness of the oxygen sensor element before a durability test;

FIG. 4B is a characteristics diagram showing durability changes in responsiveness when a responsiveness test is performed on the oxygen sensor element according to the embodiment of the present invention;

FIG. 4C is a characteristics diagram showing changes in responsiveness when a responsiveness test is performed on a conventional oxygen sensor element serving as a comparative example;

FIG. 5A is a characteristics diagram showing effects in relation to responsiveness change rate according to the embodiment of the present invention with those of the conventional example;

FIG. 5B is a characteristics diagram showing a correlation between porosity and responsiveness change rate;

FIG. 6A is a characteristics diagram showing a correlation between an average pore diameter of closed pores dispersed within an electrode layer and responsiveness change rate; and

FIG. 6B is a characteristics diagram showing a correlation between abundance ratio within grains and responsiveness change rate.

### DETAILED DESCRIPTION OF THE PREFERRED EMBODIMENTS

A gas sensor element and a method of manufacturing the gas sensor element according to an embodiment of the present invention will hereinafter be described with reference to the drawings.

[Oxygen Sensor Element]

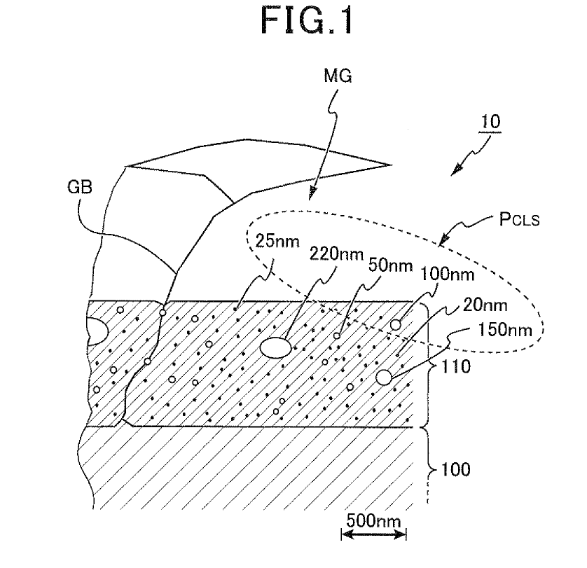

An oxygen sensor element 10 will be described as an example of a gas sensor element with reference to FIG. 1.

As shown in FIG. 1, the oxygen sensor element 10 includes a solid electrolyte body 100 having oxygen ion conductivity and an electrode layer 110 formed on the surface of the solid electrolyte body 100.

Closed pores P_{CLS} having an average pore diameter of 5 nm or more and 120 nm or less are dispersed in the electrode layer 110. The porosity in the electrode layer 110 is 1% or more and 18% or less. 90% or more of the closed pores P_{CLS} are dispersed within metal grains MG forming the electrode layer 110. However, as shown in FIG. 1, closed pores P_{CLS} having a relatively large pore diameter of 150 nm or 220 nm, although few, are present.

Here, the average pore diameter and the porosity can be determined as follows.

First, a cross-section of the oxygen sensor element 10 is cut and observed using a scanning electron microscope (SEM). The lengths of the long side and the short side of each closed pore P_{CLS} are measured, and the average length is the average pore diameter øD(nm). A pore area is determined from the average pore diameter of the closed pores P_{CLS}. The percentage of the total area of the closed pores P_{CLS} in relation to the total area of the electrode layer 110 is determined as porosity POR (%).

As a result of the closed pores P_{CLS} being dispersed in the electrode layer 110 in this way, when the electrode layer 110 is exposed to heat in a usage environment, mass transfer within the metal grains MG is suppressed, and aggregation does not easily occur. The oxygen sensor element 10 can be achieved that has stable sensor responsiveness with little durability change in responsiveness even over extended use.

In addition, it is preferred that the average pore diameter of the closed pores P_{CLS} dispersed in the electrode layer 110 is 5 nm or more and 100 nm or less. More preferably, the average pore diameter of the closed pores P_{CLS} is 10 nm or more and 50 nm or less. As a result, the durability changes in responsiveness can be reduced and durability can be improved.

Furthermore, the electrode layer 110 preferably has an alloy content of 50% or more. The alloy is at least one type or more selected from transition metals Pt, Rh, Pd, W and Mo. As a result of the electrode layer 110 being composed of a transition metal, the durability of the electrode layer 110 can be improved, and a highly reliable oxygen sensor element 10 can be achieved.

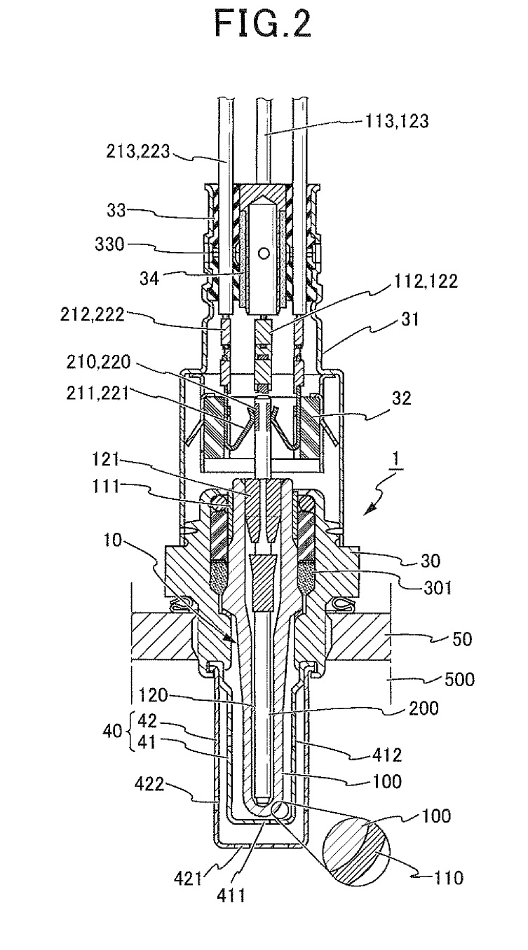

A cup-shaped oxygen sensor 1 is given as an example in which the oxygen sensor element according to the embodiment of the present invention is used. An overview of the oxygen sensor 1 is described with reference to FIG. 2.

As shown in FIG. 2, the oxygen sensor element 10 includes the solid electrolyte body 100, a reference electrode layer 120, and a measuring electrode layer 110. The reference electrode layer 120 is formed on an inner surface of the solid electrolyte body 100. The measuring electrode layer 110 is formed on the outer surface of the solid electrolyte body 100. The outer side of the measuring electrode 110 is sequentially coated by a coating layer, a catalytic layer, an anti-poisoning layer, and the like (not shown).

For example, the solid electrolyte body 100 is composed of a solid electrolyte material having oxygen ion conductivity such as zirconia. And the solid electrolyte body 100 is formed into a substantially cylindrical shape with a bottom. A leg section 101 and a bottom section 102 are formed on the tip end side of the solid electrolyte body 100. In the leg section 101, a contour in an axial cross-section that is a cross-section parallel in an axial direction of the oxygen sensor element 10 is a straight line. In the bottom section 102, the contour is a curved line. A heater 200 that generates heat by energization is inserted into the solid electrolyte body 100.

The reference electrode layer 120 and the measuring electrode layer 110 are composed of a conductive material, such as Pt.

The closed pores P_{CLS} having an average pore diameter of 5 nm to 120 nm are dispersed within the reference electrode layer 120 and the measuring electrode layer 110.

Furthermore, 90% or more of the closed pores P_{CLS} are present within the platinum grains forming the reference electrode layer 120 and the measuring electrode layer 110. The porosity measured by cross-sectional observation of the reference electrode layer 120 and the measuring electrode layer 110 is 1% or more and 18% or less.

The coating layer is an electrode protective layer that transmits measured gas 500 while covering the outer surface of the solid electrolyte body 100 including the measuring electrode layer 110. In addition, the coating layer supports a noble metal catalyst. The coating layer is composed of a metallic oxide of which the main component is at least any one of alumina, magnesia alumina spinel, and titania.

The catalytic layer is composed of a metallic oxide of which the main component is at least any one of alumina, magnesia alumina spinel, and zirconia, and a noble metal catalyst of which the main component is at least any one of Pt, Pd, Rh, and Ru.

The anti-poisoning layer is composed of a metallic oxide of which the main component is at least any one of alumina, magnesia alumina spinel, and titania.

Next, an overall configuration of the oxygen sensor 1 will be described.

As shown in FIG. 2, the oxygen sensor 1 includes a housing 30, an atmosphere-side cover 31, and an element cover 40. The heater 200 is inserted and held inside the oxygen sensor element 10. The oxygen sensor element 10 is inserted and held inside the housing 30. The atmosphere-side cover 31 is provided on the base end side of the housing 30, and covers the base end side of the oxygen sensor element 10. The element cover 40 is provided on the tip end side of the housing 30 and covers the tip end side of the oxygen sensor element 10.

The housing 30 is fixed to a wall surface of a measured gas flow path 50 through which the measured gas 500 flows. The tip of the oxygen sensor element 10 is held and fixed to be exposed to the measured gas 500.

The oxygen sensor element 10 is fixed to the inner surface side of the housing 30 composed of a metal formed into a substantially cylindrical shape, with a sealing member 301 and the like therebetween.

The atmosphere-side cover 31 is fixed to the base end side opening section of the housing 30. The element cover 40 is fixed to the tip end side opening section of the housing 30.

The element cover 40 has a two-layer cylindrical structure composed of an inner cover 41 and an outer cover 42. Opening sections 411, 412, 421, and 422 are provided on the respective side surfaces and bottom surfaces of the inner cover 41 and the outer cover 42. As a result, a structure is configured in which the oxygen sensor element 10 can be prevented from being exposed to moisture, and the measured gas 500 can be introduced to the tip end side of the oxygen sensor element 10.

The heater 200 is elastically gripped on the inner side of the solid electrolyte body 100 in the oxygen sensor element 10 by a substantially cylindrical heater holding piece 121. The heater 200 generates heat by energization.

The heater holding piece 121 also includes the reference electrode layer 120 provided on the inner side of the solid electrolyte body 100 and an electrically connected reference electrode terminal. The heater holding piece 121 is also connected to a detection means (not shown) provided externally, with a terminal piece 122 and a signal line 123 therebetween.

A substantially ring-shaped measuring electrode terminal 111 is fitted on the base end outer periphery of the oxygen sensor element 10. The measuring electrode terminal 111 is also connected to a detection means (not shown) provided externally, with a terminal piece 112 and a signal line 113 therebetween.

Conductive terminals 210 and 220 are provided on the base end side of the heater 200. Terminal pieces 211 and 221 are electrically connected to the conductive terminals 210 and 220. Furthermore, the terminal pieces 212 and 222 are connected to an energization control device (not shown) provided externally, with energization lines 213 and 223 therebetween.

An insulator 32 is held elastically within the atmosphere-side cover 31. The insulator 32 insulates and fixes the terminal pieces 112, 122, 212, and 222.

The signal lines 113, 123 and the energization lines 213, 223 are fixed and sealed on the base end side of the atmosphere-side cover 31 with an elastic member 33 therebetween.

An atmosphere introducing hole 330 is provided in the atmosphere-side cover 31 and the elastic material 33. A structure is configured in which atmosphere, serving as reference gas, is introduced to the surface of the reference electrode layer 120 provided on the inner side of the oxygen sensor element 10, with a water-repellant filter 34 therebetween.

When the oxygen sensor 1, configured as described above, is used, a concentration cell is formed by a difference between the concentration of oxygen included in the atmosphere in contact with the surface of the reference electrode layer 120 and the concentration of oxygen included in the measured gas 500 in contact with the surface of the measuring electrode layer 110. As a result of electromotive force between the reference electrode layer 120 and the measuring electrode layer 110 being measured, oxygen concentration and nitrogen oxide concentration in the measured gas 500 can be known.

[Method of Manufacturing the Oxygen Sensor Element]

Next, the method of manufacturing the oxygen sensor element will be described as an example of a method of manufacturing a gas sensor element.

First, the solid electrolyte body 100 is formed. The reference electrode layer 120 is formed on one surface of the solid electrolyte body 100, and the measuring electrode layer 110 is formed on the other surface, thereby configuring a pair of electrodes. Furthermore, the protective layer, the catalytic layer, and the anti-poisoning layer are sequentially formed on the surface of the measuring electrode layer 110. The oxygen sensor element 10 is thus formed.

Details of the manufacturing method are hereinafter described.

The solid electrolyte body 100 is formed using a zirconia powder mixture to which a predetermined amount of yttria has been added. The solid electrolyte body 100 is formed into a substantially cylindrical shape with a bottom, of which one end is sealed and the other end is opened, using a known method, such as extrusion molding, compression molding, cold isostatic pressing (CIP), or hot isostatic pressing (HIP). Then, the solid electrolyte body 100 can be formed by being fired at 1400° C. to 1600° C.

A detailed method of manufacturing the reference electrode layer 120 and the measuring electrode layer 110 in which the closed pores P_{CLS} are dispersed, which are the main sections of the present invention, will be described hereafter.

Next, the protective layer is formed on the surface of the measuring electrode layer 110 using a metallic oxide of which the main component is at least any one of alumina, magnesia alumina spinel, and titania. The protective layer serves as a bottommost layer section directly in contact with the measuring electrode layer 110 and is formed by a known method, such as application of a slurry or paste, adhesion of a green sheet, burning, or plasma spraying.

Furthermore, a slurry for forming the catalytic layer is created using a metallic oxide of which the main component is at least any one of alumina, magnesia alumina spinel, and zirconia, and a noble metal catalyst of which the main component is at least any one of Pt, Pd, Rh, and Ru. The solid electrolyte body 100 on which the protective layer has been formed is immersed in the slurry for forming the catalytic layer, and then dried and burned. As a result, the catalytic layer can be formed.

After the catalytic layer is formed, a slurry is created using a metallic oxide of which the main component is at least any one of alumina, magnesia alumina spinel, and zirconia. The anti-poisoning layer is then formed by a known method such as the solid electrolyte body 100 on which the catalytic layer has been formed being immersed in the slurry, and then dried and burned. As a result, the oxygen sensor element 10 having improved durability can be achieved. When the anti-poisoning layer is formed, a material containing an inorganic binder, such as alumina sol or silica sol, may be used.

Here, the method of manufacturing the measuring electrode layer 110 and the reference electrode layer 120 in which the closed pores P_{CLS} are dispersed will be described. The closed pores P_{CLS} have a specific average pore diameter (øD=5 nm to 120 nm).

In general, the measuring electrode layer 110 and the reference electrode layer 120 of the oxygen sensor element 10 are formed by depositing noble metal grains, serving as cores, on the surfaces of the solid electrolyte body 100 by surface preparation or the like performed in advance. A metal film is then formed by electroless deposition with the noble metal grains serving as active points. In this respect, the method is similar to a conventional method.

However, according to the present embodiment, when the metal films configuring the measuring electrode layer 110 and the reference electrode layer 120 are formed on the surfaces of the solid electrolyte body 100 by electroless deposition, a bubble distribution means is used. In the bubble distribution means, fine bubbles are applied to the surfaces of the solid electrolyte body 100, and 90% of closed pores P_{CLS} having an average pore diameter of 5 nm or more and 120 nm or less are dispersed within the metal grains MG forming the measuring electrode layer 110 and the reference electrode layer 120.

Specifically, as a first bubble distribution means, a gas introduction means is provided that introduces a gas selected from any of air, nitrogen, an inert gas such as argon, and hydrogen to a plating solution when electroless deposition is performed. The bubbles are thereby generated on the surfaces of the solid electrolyte body 110. The gas can be selected depending on the target size of the closed pores P_{CLS}.

As a result of the gas being introduced to the plating solution by the gas introduction means and electroless deposition being performed while generating bubbles in the plating solution by, a plating film can be formed in which the closed pores P_{CLS} having a desired average pore diameter are dispersed. Therefore, the closed pores P_{CLS} having the desired average pore diameter can be dispersed within the measuring electrode layer 110 and the reference electrode layer 120 formed on the surfaces of the solid electrolyte body 100, and the oxygen sensor element 10 can be manufactured that has little change in responsiveness over extended time.

Furthermore, as a result of the amount of flow of the gas introduced to the plating solution, ON and OFF control, the diameter of the opening of an introduction inlet, and the like being adjusted, the content percentage of the bubbles generated in the plating solution and the average pore diameter can be adjusted to a desired range. The average pore diameter øD(nm) of the closed pores P_{CLS}, the porosity POR(%), and the percentage PER(%) present within the grains of the closed pores P_{CLS} dispersed within the measuring electrode layer 110 and the reference electrode layer 120 can be controlled.

As a second bubble distribution means, in addition to or instead of the above-described gas introduction means, an ultrasonic wave generation means may be provided. The ultrasonic wave generation means irradiates ultrasonic waves on the solid electrolyte body 100.

As a result of irradiation of the ultrasonic waves, fine bubbles can be generated on the surface of the solid electrolyte body 100 by vaporizing the plating solution. Alternatively, the bubbles introduced to the surface of the solid electrolyte body 100 by the above-described gas introduction means can be broken. As a result, adjustment can be made to achieve a smaller pore diameter. As a result, the measuring electrode layer 110 and the reference electrode layer 120 having even higher durability can be formed.

In addition, by the transmitted frequency and output strength of the ultrasonic waves vibrated from the ultrasonic wave generation means being controlled, the diameter of the generated bubbles can be more accurately adjusted.

As a third bubble distribution means, a plating solution can be used that generates bubbles on the surface of the solid electrolyte body 100 by chemical reaction when electroless deposition is performed.

Specifically, as a plating solution that generates bubbles through chemical reaction, for example, a solution that contains Pt ammine complex and a reductant (sodium borohydride [SBH]) is given. When the solution comes into contact with the active points on the surface of the solid electrolyte body 100, H₂ is generated by the Pt ammine complex and the reductant. The plating solution is not limited to the example above. Any solution can be used accordingly as long as the solution generates bubbles on the surface of the solid electrolyte body 100 during the process of chemical reaction in electroless deposition.

As a result of the bubbles being generated by chemical reaction as described above, the H₂ generated on the surface of the solid electrolyte body 100 is taken into the Pt film during the process for forming the plate film. The closed pores P_{CLS} having a uniform pore diameter can be dispersed within the measuring electrode layer 110 and the reference electrode layer 120.

As a result of the surface preparation and the like, the cores composed of Pt or the like can be formed in the area in which the plate film is to be formed and the above-described active points can be formed in advance on the surfaces of the solid electrolyte body 100.

As a result, the closed pores P_{CLS} having the desired average pore diameter øD (5 nm to 120 nm) are dispersed within the measuring electrode layer 110 and the reference electrode layer 120 formed on the surfaces of the solid electrolyte body 100. Therefore, reduction in the size of the metal grains MG forming the measuring electrode layer 110 and the reference electrode layer 120 can be suppressed. A highly reliable oxygen sensor element 10 having little durability change in responsiveness over an extended period can be manufactured.

As described above, the measuring electrode layer 110 and the reference electrode layer 120 in which nano-sized closed pores P_{CLS} formed by electroless deposition are dispersed may be burned by heat treatment at a higher temperature. During heat treatment, the closed pores Pus dispersed within the metal grains MG rarely move outside of the metal grains MG. Therefore, the measuring electrode layer 110 and the reference electrode layer 120 can be achieved that have even higher durability.

On the other hand, in conventional electroless deposition, pores are formed as defects during formation of the plate film. Therefore, the pores may coincidentally remain as closed pores within the metal grains. However, most pores are present in the grain boundaries between the metal grains. Very few pores are present within the metal grains.

During sintering of sintered metals, ceramics, paint films, and the like, during the process of grain growth of the material particulate grains by heat treatment, heating speed is adjusted such that pores do not remain within the grains. In general, characteristics such as durability of a bulk body is achieved by performing densification while releasing pores present in the grain boundaries, as described above.

On the other hand, according to the present embodiment, the closed pores P_{CLS} of a specific nano-size are dispersed in the measuring electrode layer 110 and the reference electrode layer 120 formed on the surfaces of the solid electrolyte body 100. As a result, even when the oxygen sensor element 10 is exposed to a heated environment, mass transfer within metal grains MG is suppressed, and aggregation of the metal grains MG forming the measuring electrode layer 110 and the reference electrode layer 120 does not easily occur. As a result, based on the new discovery that the durability of the oxygen sensor element 10 can be improved, the inventors of the present invention have found the foregoing through keen examination.

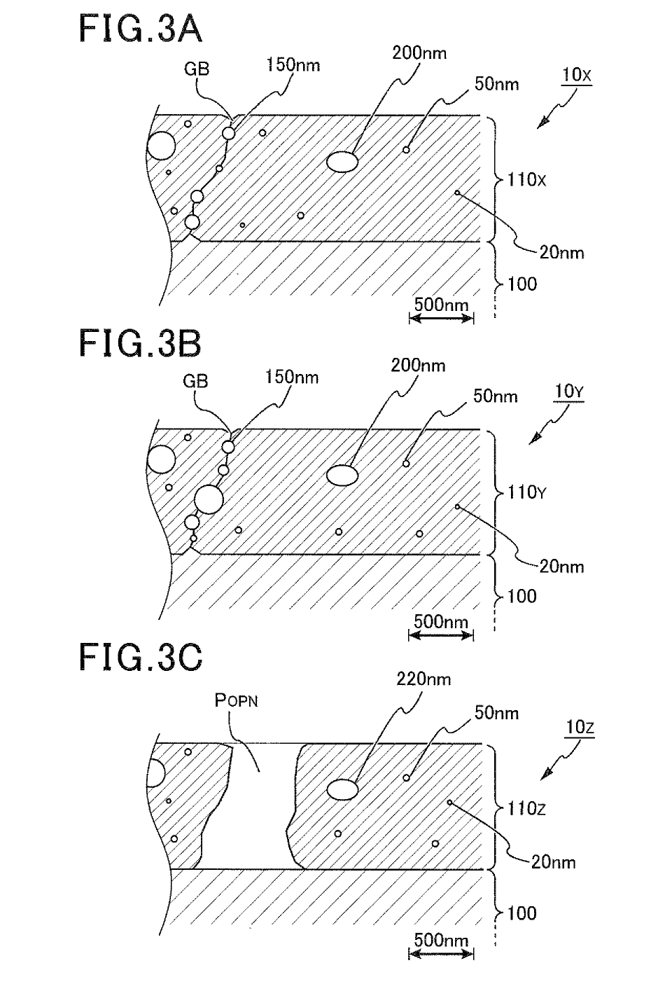

Here, an overview of conventional oxygen sensor elements 10_{X}, 10_{Y}, and 10_{Z} will be described with reference to FIG. 3A to FIG. 3C.

In the conventional oxygen sensor element 10_{X} indicated as a first comparative example in FIG. 3A, the amount of closed pores P_{CLS} present within an electrode layer 110_{X} is small, with a total area ratio of about 2%. Most of the closed pores P_{CLS} present within the electrode layer 110_{X} are relatively large with a pore diameter of 150 nm or 200 nm. Fine closed pores P_{CLS} with a pore diameter of 20 nm and 50 nm mare very few.

In the conventional oxygen sensor element 10_{Y} indicated as a second comparative example in FIG. 3B, very few closed pores P_{CLS} are present within the metal grains forming an electrode layer 110_{Y}. Most of the closed pores P_{CLS} are present in the grain boundaries GB between metal grains.

Most of the closes pores P_{CLS} present in the grain boundaries GB are relatively large with a pore diameter of 150 nm or 200 nm. Only the rare closed pores P_{CLS} with a pore diameter of 50 nm and 20 nm can be observed.

Furthermore, in the conventional oxygen sensor element 10z indicated as a third comparative example in FIG. 3C, large open pores P_{OPN} are present in the grain boundaries between the metal grains forming an electrode layers 110_{Z}.

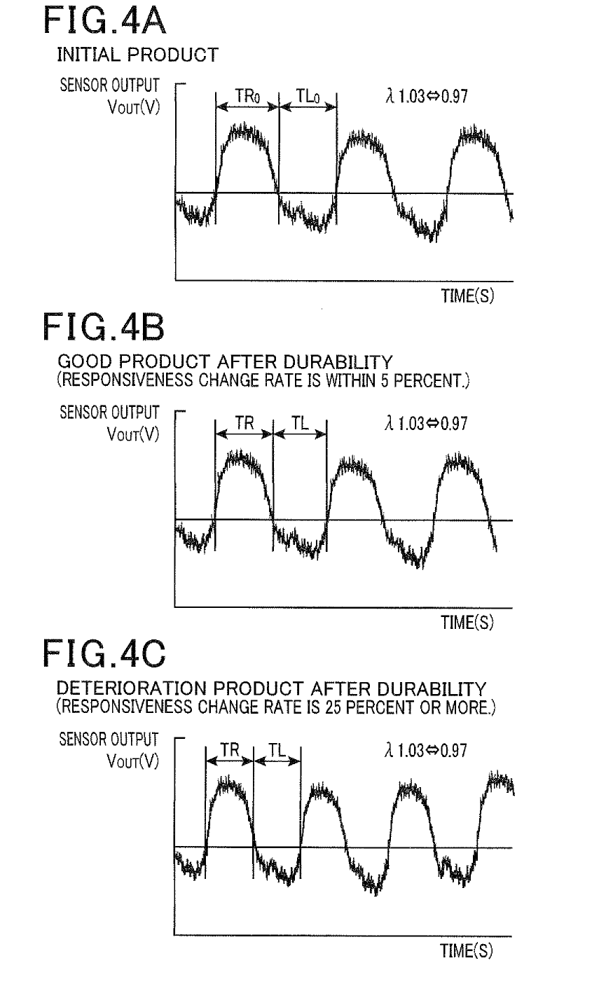

Durability changes in responsiveness studied to confirm the effects of the present invention will further be described with reference to FIG. 4A to FIG. 4C.

First, the oxygen sensor element 10 according to the embodiment of the present invention was mounted in an exhaust gas flow path of an actual engine. Regarding the sensor output V_{OUT} (V) when the air/fuel ratio A/F was switched from λ=1.03 (rich) to λ=0.97 (lean), the time indicating rich response was rich response time TR and the time indicating lean response was lean response time TL. The sum of the rich response time TR and the lean response time TL is defined as the response time. To support the accuracy of the evaluation, an average value of five cycles was used as the response time.

In relation to the response time (TR₀+TL₀) of an initial product before durability test shown in FIG. 4A, in the oxygen sensor element 10 according to the embodiment of the present invention, as shown in FIG. 4B, the responsiveness change rate CHR after the durability test was low, within 5%. On the other hand, in the conventional oxygen sensor element 10_{Z} shown in FIG. 4C, the responsiveness change rate CHR after the durability test was low, at 25% or more.

The following experiment was performed using an example to confirm the effects of the oxygen sensor element 10 of the present invention.

### EXAMPLE

In the present example, samples 1 to 34 were prepared that have differing porosity POR(%) and average pore diameter øD of the closed pores P_{CLS} dispersed within the measuring electrode layer 110 and the reference electrode layer 120 formed on the surface of the solid electrolyte body 100, and percentage PER(%) of closed pores P_{CLS} present within the metal grains MG. Specifically, as shown in Table 1, the porosity POR(%), or in other words, the total cross-sectional area ratio of the closed pores P_{CLS} to the cross-sectional area of the electrode layer was changed between 0.5% and 25.5%. The average pore diameter øD was changed between 3 nm to 150 nm. The percentage PER(%) of the closed pores P_{CLS} present within the metal grains MG was changed between 70% and 97%.

Here, the average pore diameter øD of the closed pores P_{CLS} and the porosity POR(%) were determined as follows.

First, a cross-section of the oxygen sensor element 10 was cut by focused ion beam (FIB), cross-section polisher (CP), or the like that has little damage on the metal films. The cross-section was observed using a scanning electron microscope (SEM). Specifically, a rectangular area formed with the thickness of the electrode layer 110 as a vertical width and a length twice the thickness of the electrode layer 110 as a horizontal width in the direction perpendicular to the thickness direction of the electrode layer 110 serves as an observation surface. Three rectangular areas were arbitrarily selected. Measurement was performed on the cross-sections of the three areas of the electrode layer 110. The lengths of the long side and the short side of the closed pores P_{CLS} present in the rectangular areas were each measured. An average of the measured lengths was used as the average pore diameter øD(nm). The pore area was calculated from the average pore diameter, and the percentage of the total area of the closed pores P_{CLS} to the total area of the electrode layer 110 was calculated as the porosity POR(%).

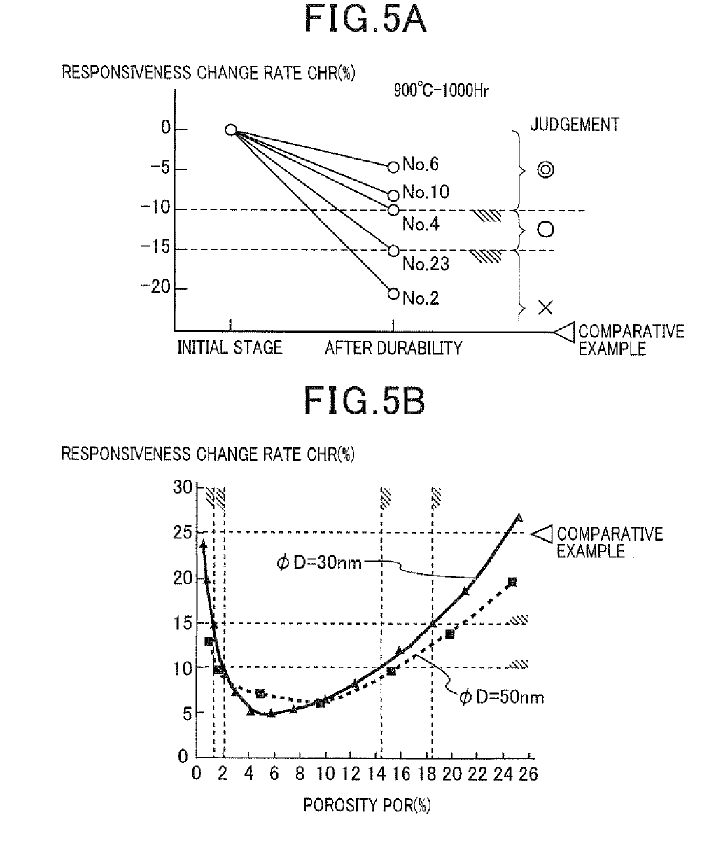

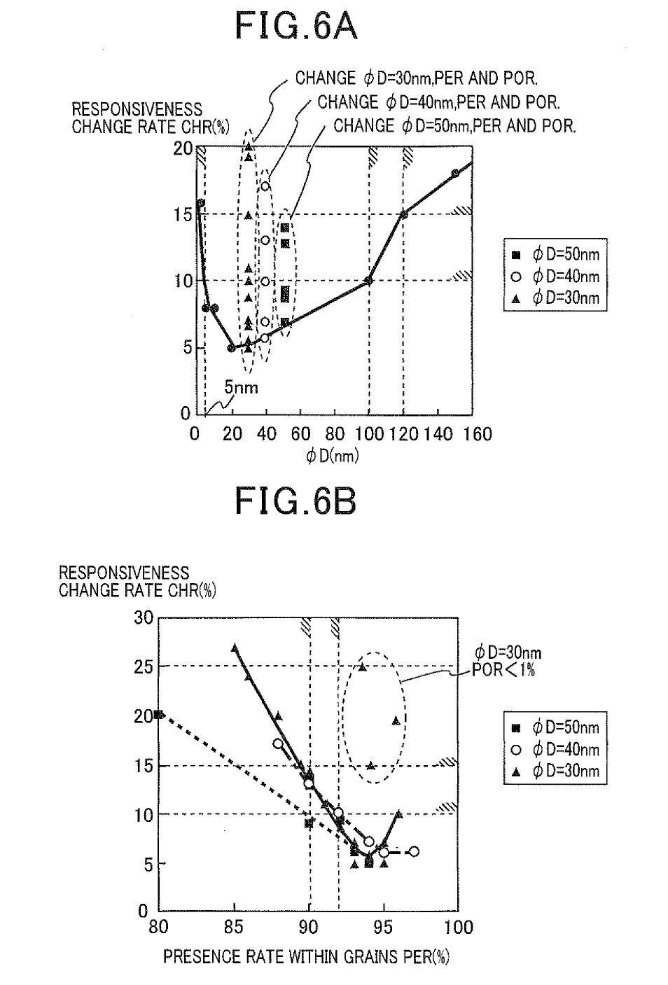

Regarding each sample 1 to 34, the responsiveness change rate CHR (%) was measured. The experiment results are shown in Table 1, FIG. 5A, FIG. 5B, FIG. 6A, and FIG. 68.

TABLE 1

| | POR | φ D | PER | CHR | JUDGE- |
|---|---|---|---|---|---|
| SAMPLE | (%) | (nm) | (%) | (%) | MENT |
| 1 | 0.5 | 30.0 | 93 | 25.0 | X |
| 2 | 0.8 | 30.0 | 96 | 20.0 | X |
| 3 | 0.9 | 30.0 | 94 | 15.5 | X |
| 4 | 2.1 | 30.0 | 96 | 10.0 | ◯ |
| 5 | 3.2 | 30.0 | 95 | 7.0 | ⊚ |
| 6 | 4.6 | 30.0 | 93 | 5.0 | ⊚ |
| 7 | 6.2 | 30.0 | 95 | 5.0 | ⊚ |
| 8 | 8.1 | 30.0 | 94 | 5.6 | ⊚ |
| 9 | 10.0 | 30.0 | 93 | 6.8 | ⊚ |
| 10 | 12.7 | 30.0 | 92 | 8.7 | ⊚ |
| 11 | 15.4 | 30.0 | 92 | 11.0 | ⊚ |
| 12 | 18.4 | 30.0 | 90 | 15.5 | X |
| 13 | 21.6 | 30.0 | 92 | 17.0 | X |
| 14 | 25.2 | 30.0 | 85 | 25.0 | X |
| 15 | 1.0 | 50.0 | 90 | 13.0 | ◯ |
| 16 | 2.0 | 50.0 | 90 | 9.0 | ⊚ |
| 17 | 5.0 | 3.0 | 96 | 17.0 | X |
| 18 | 5.0 | 5.0 | 95 | 8.0 | ⊚ |
| 19 | 5.0 | 10.0 | 95 | 8.0 | ⊚ |
| 20 | 5.0 | 20.0 | 94 | 5.0 | ⊚ |
| 21 | 5.0 | 50.0 | 92 | 7.0 | ⊚ |
| 22 | 5.0 | 100.0 | 92 | 10.0 | ◯ |
| 23 | 5.0 | 120.0 | 90 | 15.0 | ◯ |
| 24 | 5.0 | 150.0 | 70 | 18.0 | X |
| 25 | 10.0 | 50.0 | 93 | 6.3 | ⊚ |
| 26 | 15.0 | 50.0 | 92 | 9.5 | ⊚ |
| 27 | 20.0 | 50.0 | 90 | 14.0 | ◯ |
| 28 | 25.0 | 50.0 | 80 | 20.0 | X |
| 29 | 3.0 | 40.0 | 97 | 6.0 | ⊚ |
| 30 | 3.0 | 40.0 | 95 | 6.0 | ⊚ |
| 31 | 3.0 | 40.0 | 94 | 7.0 | ⊚ |
| 32 | 3.0 | 40.0 | 92 | 10.0 | ◯ |
| 33 | 3.0 | 40.0 | 90 | 13.0 | ◯ |
| 34 | 3.0 | 40.0 | 88 | 17.0 | X |

As shown in Table 1 and FIG. 5A, the responsiveness change rate CHR (%) of the conventional oxygen sensor element indicated as a comparative example was 25%. Therefore, samples in which a reduction effect of 10% or more from that of the comparative example could not be seen, taking into consideration measurement error, individual differences, and the like, or in other words, samples having a responsiveness change rate CHR(%) of 15% or more were judged to have no effect and are indicated by x. Samples having a responsiveness change rate CHR(%) of 15% or less were judged to have effect and are indicated by ∘. Samples having a responsiveness change rate CHR(%) of 10% or less were judged to have significant effect and are indicated by ⊚.

As shown in Table 1 and FIG. 5B, the responsiveness change rate CHR(%) was found to become 15% or less as a result of the porosity POR(%) exceeding 1% and being 18% or less. In addition, the responsiveness change rate CHR(%) was found to become 10% or less as a result of the porosity POR(%) being 2% or more and 14% or less.

As shown in FIG. 6A, the responsiveness change rate CHR(%) was found to become 15% or less as a result of the average pore diameter øD of the closed pores P_{CLS} being 5 nm or more and 120 nm or less. In addition, the responsiveness change rate CHR(%) was found to become 10% or less as a result of the average pore diameter øD of the closed pores P_{CLS} being 100 nm or less. Moreover, the responsiveness change rate CHR(%) was found to have become halved to 7% or less as a result of the average pore diameter øD of the closed pores P_{CLS} being 10 nm or more and 50 nm or less.

As shown in FIG. 6B, the responsiveness change rate CHR(%) was found to become 15% or less as a result of the presence percentage PER(%) of closed pores P_{CLS} within the grains being 90% or more. In addition, the responsiveness change rate CHR(%) was found to become 10% or less as a result of the presence percentage PER(%) of closed pores P_{CLS} within the grains being 93% or more.

The gas sensor element of the present invention is not limited to the above-described embodiment. Modifications can be made accordingly without departing from the scope of the present invention. The present invention improves durability of the gas sensor element by dispersing the closed pores having a predetermined average pore diameter in the electrode layers at a predetermined percentage, suppressing mass transfer in the metal grains forming the electrode layers, and preventing aggregation of metal grains resulting from extended use.

For example, according to the present embodiment, an example of a so-called cup-shaped oxygen sensor element is described. However, the gas sensor element of the present invention is not limited to the oxygen sensor element. The present invention can also be used accordingly as a gas sensor element (such as a NO_{X} sensor, an ammonia sensor, or an air/fuel ratio sensor) that detects a selected component (such as NO_{X} or ammonia) within a measured gas.

The technical concept of the present invention that improves durability of the electrode layers by dispersing closed pores having a specific average pore diameter in the electrode layers can also be used in a so-called stacked gas sensor.

What is claimed is:

1. A gas sensor element that detects concentration of a selected component included in a measured gas, including a solid electrolyte body having oxygen ion conductivity; and electrode layers formed on both surfaces of the solid electrolyte body configuring a pair of electrodes, wherein
closed pores having an average pore diameter of 5 nm or more and 120 nm or less are dispersed in the electrode layers,
porosity measured by cross-sectional observation of the electrode layers is 1% or more and 18% or less, and
90% or more of the closed pores are dispersed within metal grains forming the electrode layers.

2. The gas sensor element according to claim 1, wherein
the average pore diameter of the closed pores is 5 nm or more and 100 nm or less.

3. The gas sensor element according to claim 1, wherein
the average pore diameter of the closed pores is 10 nm or more and 50 nm or less.

4. The gas sensor element according to claim 1, wherein
the electrode layer has an alloy content of 50% or more, and
the alloy includes at least one or more selected from transition metals Pt, Rh, Pd, W and Mo.

5. The gas sensor element according to claim 1, wherein
the porosity is 2% or more and 14% or less.

6. The gas sensor element according to claim 1, wherein
93% or more of the closed pores are dispersed within metal grains forming the electrode layer.

7. The gas sensor element according to claim 1, wherein
the gas sensor element is an oxygen sensor element.

8. A method of manufacturing a gas sensor element by forming at least a metal film configuring an electrode layer on a surface of a solid electrode body having oxygen ion conductivity, and the gas sensor element that detects concentration of a selected gas component within a measured gas, said method comprising the step of
applying fine bubbles on the surface of the solid electrolyte body when forming the metal film by electroless deposition for dispersing 90% or more of closed pores having an average pore diameter of 5 nm or more and 120 nm or less within metal grains forming the electrode layer.

9. The method of manufacturing a gas sensor element according to claim 8, wherein
the step of applying fine bubbles is introducing a gas selected from any of air, nitrogen, an inert gas, and hydrogen to a plating solution when electroless deposition is performed, for generating the bubbles on the surfaces of the solid electrolyte body.

10. The method of manufacturing a gas sensor element according to claim 8, wherein
the step of applying fine bubbles is using a plating solution that generates bubbles on the surface of the solid electrolyte body by chemical reaction when electroless deposition is performed.

11. The method of manufacturing a gas sensor element according to claim 8, wherein
the step of applying fine bubbles includes irradiating ultrasonic waves on the solid electrolyte body.

12. The method of manufacturing a gas sensor element according to claim 8, said method including the step of
firing the measuring electrode layer and the reference electrode layer by heat treatment at a higher temperature after the electroless deposition is performed.
